(19) United States
(12) Patent Application Publication
(10) Pub. No.: US 2023/0171267 A1
(43) Pub. Date: Jun. 1, 2023

(54) SELECTIVE SECURITY SCAN TO REDUCE SIGNATURE CANDIDATES

(71) Applicant: McAfee, LLC, San Jose, CA (US)

(72) Inventors: German Lancioni, San Jose, CA (US); Cedric Cochin, Portland, OR (US); Carl D. Woodward, Santa Clara, CA (US)

(73) Assignee: McAfee, LLC, San Jose, CA (US)

(21) Appl. No.: 17/535,947

(22) Filed: Nov. 26, 2021

(51) Int. Cl. H04L 9/40; G06F 21/60; G06F 21/55; G06F 16/28; G06F 21/54; G06F 21/64

(52) U.S. Cl. CPC H04L 63/1416; G06F 21/602; G06F 21/554; G06F 16/285; G06F 21/54; H04L 63/1433; G06F 21/64

(57) ABSTRACT

A computing apparatus includes a hardware platform having a processor circuit and a memory; a network interface; and instructions encoded within the memory to instruct the processor circuit to: extract data from an object under analysis; compute a partial match value according to a partial match algorithm of the extracted data; send the partial match value to a remote service via the network interface; receive from the remote service, via the network interface, a list of candidate signatures that correspond to the partial match value, wherein the candidate signatures are a superset of true matches to the object under analysis; compare the object under analysis to the candidate signatures; and if the compare identifies one or more matching signature, classify the object under analysis as belonging to a same class as at least one second object that is a source of a matching signature.

### FIELD OF THE SPECIFICATION

This specification relates to the field of computer security and more particularly, though not exclusively to, a selective security scan to reduce signature candidates.

### BACKGROUND

Contemporary computing practice may include a concept of scanning various objects. A scan may include comparing a test sample to multiple candidates to find a match. Scanning can be used in many contexts, such as in the context of security where objects are scanned and compared to known malicious objects.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a security ecosystem.

FIG. 2 is a block diagram of an endpoint device.

FIG. 3 is a block diagram of a processing pipeline.

FIG. 4 is a block diagram of a processing pipeline.

FIG. 5 is a block diagram illustrating the operation of a partial match algorithm.

FIGS. 6A and 6B are a flow chart of a method of performing a partial match.

FIG. 7 is a flowchart of a cloud method.

FIG. 8 is a block diagram of selected elements of a hardware platform.

FIG. 9 is a block diagram of selected elements of a network function virtualization (NFV) infrastructure.

FIG. 10 is a block diagram of selected elements of a containerization infrastructure.

### SUMMARY

A computing apparatus includes a hardware platform having a processor circuit and a memory; a network interface; and instructions encoded within the memory to instruct the processor circuit to: extract data from an object under analysis; compute a partial match value according to a partial match algorithm of the extracted data; send the partial match value to a remote service via the network interface; receive from the remote service, via the network interface, a list of candidate signatures that correspond to the partial match value, wherein the candidate signatures are a superset of true matches to the object under analysis; compare the object under analysis to the candidate signatures; and if the compare identifies one or more matching signature, classify the object under analysis as belonging to a same class as at least one second object that is a source of a matching signature.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Many contemporary computer problems require scanning of an object, such as a file, a portable executable (PE), a fileless object, a URL, a webpage, a document object model (DOM) object, or some other object or data structure that appears on a computing system. Scanning generally includes comparing the object under analysis to some other set of objects with known properties. A common and useful case for scanning is in the antivirus context. When a new object is encountered on the computing system, a security agent has not yet assigned a reputation to that object. This can also be the case where the object has a previous reputation, but the object has changed in some way. Because the object does not have a known reputation, the security architecture, such as a security agent, does not know whether the object is safe for execution or other function on the computing platform. So the security agent scans the object. Scanning can include comparing the object to a set of other objects with known properties. For example, the other objects may be known malware, and the scan includes comparing the new object to a plurality of other objects that are known to be malicious. If the new object matches—either fully or partially—to one of the known malicious objects, then the new object may be convicted as malware based on that similarity.

The scan itself may include a pattern matching, such as a signature, heuristic, hash, or similar. For example, the scan can include extracting all strings from the binary object. These strings can be a useful indicator of the character of the object. The string set can be hashed, in whole or in part, or otherwise conditioned. The string set may then be compared to the string signatures of a set of known objects. This is a method commonly performed in traditional antivirus detection schemes. The strings, or a hash, fuzzy hash, or other data extracted from the object or the extracted strings, is compared to other objects or signatures of other objects (such as strings extracted from those objects, or hashes of strings or sets of strings extracted from those objects). In general terms, the system may build one or more signatures for the test object and compare it to signatures of other objects. Note that in the context of this specification, a “signature” may include any data used to characterize an object. Comparing signatures could include anything from bitwise comparisons of entire binary objects, to comparisons of included strings, to comparison of hashes of the entire binary object, to comparison of hashes of strings, substrings, or groups of strings.

One challenge with so-called “signature-based scanning” is that, in some existing systems, the cloud service that hosts and maintains a database of known malware signatures may mirror the entire database to each protected endpoint device. This allows the endpoints to check unknown objects against all known threats. However, this mechanism can be expensive in terms of bandwidth, storage, and memory, and produce a significant performance impact on the system executing the scan. Because the goal of a security agent or architecture is ultimately to aid the user in successfully operating the computer, a security agent that has an undue performance impact on the system is essentially self-defeating. The system also becomes complicated because of the large number of signatures. For example, McAfee Inc. is a leading security services provider that has been collecting and characterizing malware since the 1980s. Such services may have security researchers that continuously collect samples of malicious objects, and add their signatures to the database over time, thus providing a comprehensive list of malware signatures that can be used in a security scan. An unknown object (or a signature of an unknown object) can be compared to the signatures of each of these other objects, and a positive match can be used to convict the object under analysis.

This signature-based analysis builds a cumulative database over time. A malware object that appears in the wild may remain a relevant and credible threat for many years after. So once an object is added to the signature database, it will generally be a long time—if ever—before the object is removed from the signature database. For example, McAfee has collected and characterized millions of malware objects since the 1980s, and the list grows as an ever-increasing rate as threats proliferate. This means that the signature database is an ever-growing data structure that is replicated out to each individual client node as the client node scans objects with unknown reputations. Furthermore, client devices periodically pull updates from a cloud service to ensure that they have the latest malware definitions.

Compared to mirroring the full malware database to every endpoint, benefits may be realized by maintaining an object database in the cloud. For example, a cloud-based solution is instantaneously updated once an object is added to the database. This contrasts with a local cache of the database, which may be updated periodically, and thus has a coverage gap in the time between when an object is added to the cloud database and cached in the local database.

Another advantage of a cloud-based signature database is the danger of data leakage. When the full signature database is replicated to each and every client device, there is danger that malware authors and other attackers may reverse engineer the signatures to determine which objects and patterns have been identified, or they may continuously run malware samples against the full, local database to see if they are detected. Thus, some malware authors can use anti-malware services to build more dangerous (and harder to detect) malware.

One challenge with a cloud-based solution is that objects under analysis need to be offloaded to the cloud for analysis. For example, if an object is to be analyzed in the cloud, the object may be uploaded to the cloud and then analyzed. This has a danger of leakage of personally identifying information (PII) or other similar sensitive information leakage. Commonly, users will not want the security services provider to have unfettered access to the users' files, bank account information, Bitcoin, Social Security numbers, or other data that may be exposed by uploading files to the cloud.

A pure cloud-based solution can also be inefficient. It may require time for the endpoint to upload the data to the cloud and then wait for analysis results before the user can move forward with using the application or file. This interferes with the user's use and enjoyment of the computer. A likely result is that the user would simply become frustrated with the security agent and uninstall it, leaving the user exposed to threats, or sending the user to a different provider.

However, a hybrid solution is possible in which analysis occurs on the endpoint but does not require a full signature database. For example, in an illustrative embodiment, certain data or metadata may be extracted from an object under analysis, such as a PE. A hashing or partial match algorithm may be a partial match algorithm. The partial match algorithm may be considered a “fuzzy” match or one that is lower resolution than a full hash or comparison. Depending on the partial match algorithm used, the algorithm may be guaranteed to match an object that would also be matched by a full hash (i.e., no “false negatives”). Alternatively, an algorithm may be used that has some, but very few, false negatives. By design, the partial match algorithm can also have “false positives” (e.g., objects that match the partial match algorithm, but not a full-match comparison to the object). Thus, the partial match algorithm is not determinative, but returns a list of candidate objects or candidate signatures. In some embodiments, it is guaranteed (or at least highly likely) that an object or signature that would match according to a full-match algorithm will match any object that would be matched by the partial-match algorithm. Thus, “true matches” (e.g., a match that would be found by a full-match algorithm) are a subset of matches for the partial match algorithm.

One such partial match algorithm is the MinHash algorithm. Hashing itself may be considered a partial match algorithm relative to a full byte-by-byte comparison of two files. Because byte-by-byte comparison against a large number of files would be highly inefficient and create a serious performance issue, hashes are often used to identify matching files. The hash may be thought of as a lossy compression algorithm, wherein multiple binary files could yield the same hash. But the probability of two random files having the same hash is extremely small. The probability of two random files that do something useful—as opposed to two random sequences of bits—is astronomically low. Thus, various hash algorithms can be used to identify a file with near deterministic certainty.

On the other hand, MinHash does not identify an object with deterministic certainty. Generally, the resolution of a MinHash algorithm is determined by the bit size of the MinHash. A one- or two-bit MinHash would match almost every file and so would provide little advantage over existing systems that download the entire signature database. The MinHash could also be 4 bits, 16 bits, 32 bits, 64 bits, 128 bits, 256 bits, 512 bits, 1024 bits, 2048 bits, 4096, or 8192 bits, by way of illustrative and nonlimiting example. An 8192-bit MinHash would be highly specific and would have a near certainty of matching only one file. Generally, any bit depth of MinHash may be used with the present specification. In an illustrative embodiment, a 128-bit or 256-bit MinHash is used to provide a good trade-off between speed and sample size. In the case of a computer security scan, the number of signatures may be on the order of millions of objects. Using a 128-bit or 256-bitf MinHash, the subset of objects returned will usually be on the order of ones to tens of objects. This provides a much smaller search space for the security scan algorithm.

In an illustrative example, a security agent encounters a new object on the computing system. This object could be a file, an executable, a PE, a fileless object, a living-off-the-land object, a plug-in, a URL, a website, a scheduled event, a command line string, or any other suitable object for analysis. Rather than mirroring an entire database of signatures from a security services provider, a security agent on the device performs a MinHash (such as a 128-bit MinHash) on the object. The security agent can then send the 128-bit MinHash to the security services provider. Advantageously, this does not reveal any of the underlying information that the MinHash was derived from so that the users' PII is protected. The security agent then sends the MinHash to a security services provider. On the cloud side, the security services provider uses the 128-bit MinHash as an index into the search space of its much larger database of security object signatures. The cloud service then returns to the client only those signatures that matched the 128-bit MinHash. Once those are returned to the endpoint, the security agent on the endpoint can use only that subset of signatures as the search space for its security scan.

Advantageously, this method is guaranteed to catch any signature that would be caught by mirroring the full database. The MinHash is guaranteed (or almost guaranteed, depending on the specific parameters) to match even though it would have false positives. Further advantageously, only a small portion of the full security object database needs to be cached on the local endpoint. This saves computing bandwidth and computing power on the endpoint. This cache can be maintained with a time to live, such as on the order of a few days. When a new object is scanned, the security agent needs to retrieve from the cloud only those signatures that have not already been cached in the local database. This further improves efficiency. Further advantageously, this solution scales better than the traditional method of mirroring the entire signature database on each and every endpoint throughout the security ecosystem.

The system of the present specification provides a data sketch structure to index the raw content (for example, the strings that appear within an executable object). The data sketch structure can be used in a client-to-cloud staged interaction to query for candidate signatures using a fixed-length MinHash that represents the sample content. In this way, only a fraction of the total universe of available signatures is pushed to the endpoints in a just-in-time fashion. This allows the endpoint to build a small custom-owned repository of relevant signatures that are tailored to the individual use case.

This realizes advantages over certain existing solutions. For example, existing ecosystems may use an ever-growing number of signatures that are pushed in full to every endpoint. Every endpoint receives the same bulky package, even though the vast majority of signatures do not provide any value to the endpoint, as they are never matched against an object that appears on the endpoint. The system also realizes greater efficiency in scanning. This is in contrast to existing ecosystems that may go through all possible signatures until a match is found. These systems may attempt to match every available signature using only some simple filters, such as file type filters, which do not produce performance improvements on the order of those realized by the present specification.

Some existing ecosystems also suffer from adversarial weakness by exposing the content and associated detections to the endpoint. This allows the adversaries to test against the latest signatures before shipping a new piece of malware. If the adversary's malware is not found in the large batch of signatures, the malware author may have confidence that it will not be detected in the wild.

Furthermore, some existing ecosystems lack real-time content protection. Newly authored content, such as signatures, fixes, or similar, may not be immediately available to endpoints. Instead, endpoints may need to consume the new content on the next update cycle, which may be in a matter of days or weeks later. This exposes the customer to novel threats and/or introduces user experience friction when there is a malfunction because a content fix was not published yet. While existing ecosystems may attempt to address the real-time issue by making updates more frequent, this can be difficult because of the large volume of data that are pushed out in a single update.

The data sketch index structure of the present specification provides that only a subgroup of candidates is pushed to the endpoint for scanning purposes in contrast to the entire signature database. This makes scanning more effective as it only considers a subset of the total universe of available signatures. For example, in typical use case, less than 5 percent of the total signature database is returned to an endpoint. The less generic the signatures are, the more efficient the scanning process becomes.

Further advantageously, content data may be available in real-time or just-in-time. When an endpoint queries the cloud, only a subgroup of candidates, along with their fresh content, is pushed for scanning purposes. This eliminates the need to deploy or update endpoints. Once the content is pushed, it can be cached and reused later for fast processing during a given TTL.

Furthermore, the system of the present specification may require less memory than some existing ecosystems. This is because there is no need to load an entire signature database on the endpoint. Furthermore, the system may use a smaller disk footprint or storage footprint because there is no need to store the entire signature database on the endpoint. This allows the otherwise prohibitively expensive object extraction and scanning process to be performed even on low resource devices, such as older machines, internet of things (IoT) devices, embedded devices, and headless devices.

Furthermore, the present specification provides a lightweight client-to-cloud interaction that relies on MinHash, which reduces the amount of data sent to the cloud by orders of magnitude. Further advantageously, the use of a MinHash—rather than sending the entire object—also helps to protect the user's PII.

The present specification operates on test samples or objects under analysis. These may be, by way of illustrative example, a PE file that is to be compared against certain pattern definitions, such as signatures, heuristics, or other patterns. If a test sample matches a known pattern, then the test sample can be classified into a particular category. For example, if the object under analysis matches the signature of another object, then the object under analysis may inherit the signature of the other object, such as malware, threat, benign, unknown, suspicious, or similar.

Throughout this specification, malware identification is provided as an illustrative use case of the teachings of the present specification. However, the teachings of the present specification can also be extended to other use cases wherein it is valuable or desirable to provide a partial match to a signature or characteristics database. This can apply to many different vertical use cases that require scanning for matches between a test sample and a large collection of known patterns.

In an illustrative method, content from the test sample may be extracted by the endpoint. The content may be any kind of data useful to produce a match against known signatures, rules, heuristics, or other characteristics. For the use case example of a malware match, one common way of identifying malware is to extract all the strings contained in the test sample, e.g., a PE. Once the content is extracted, a MinHash, such as a 256-bit MinHash may be computed. The MinHash is a hash that aims to collide when similar content is hashed. The more resolution the MinHash has, the more precise the representation is. In this case, a 256-bit MinHash is used as a trade-off between precision and efficiency. The value of the MinHash could be higher or lower depending on the application sensitivity. Another advantageous property of MinHash is that it does not leak potential PII that may be contained in the test sample.

After the MinHash has been computed, the MinHash is sent to a cloud service as part of a query. The query is intended to obtain a list of potential signatures or patterns to check the test sample against. These may be known as candidates or as potential matches. A property of a candidate or potential match is that a potential match set includes all objects, signatures, or other data from the database that would match the sample if a full-match algorithm were performed. The candidate or potential match set may also include one or more false positive matches. In other words, all true matches are guaranteed to be a subset of the candidate or potential matches.

To achieve this result, the cloud may use a data sketch index structure, such as a locality sensitive hashing (LSH) ensemble. An LSH ensemble is a structure that is used to satisfy containment queries and may provide advantages over simpler queries, such as Jaccard. Advantageously, LSH may be preferred over Jaccard because LSH is agnostic to the varying set sizes. This is valuable for some use cases because patterns or signatures may be very small. For example, “match strings A, B, and C” may be used as a pattern or signature. The query set size (all strings from the PE test sample) could be many times bigger, such as two orders of magnitude larger, in one illustrative example.

Jaccard similarity would be problematic for this use case because not all sets have the same size. However, LSH ensemble obtains all the signatures/patterns that contain at least a threshold T (e.g., 0.01) number of matching set elements. This is performed in a normalized way. Because this is a containment query and it only checks for intersection of sets (sets from the signatures group versus the query set), the resulting intersection produces a small group of candidates. The size of the group of candidates will depend on the specificity of the signatures. In some use cases, the group could be less than 5 percent of the total universe of signatures.

This smaller subset of signatures can then be returned to the endpoint, and the endpoint can perform its signature matching against just that small subset. Advantageously, the dataset returned to the endpoint is much smaller than in the case of exporting the entire subset to the endpoint. Furthermore, scanning on the endpoint is more efficient because the endpoint is scanning only a small subset of the total database of signature matches.

The foregoing can be used to build or embody several example implementations, according to the teachings of the present specification. Some example implementations are included here as nonlimiting illustrations of these teachings.

In one example, there is disclosed a computing apparatus, comprising: a hardware platform comprising a processor circuit and a memory; a network interface; and instructions encoded within the memory to instruct the processor circuit to: extract data from an object under analysis; compute a partial match value according to a partial match algorithm of the extracted data; send the partial match value to a remote service via the network interface; receive from the remote service, via the network interface, a list of candidate signatures that correspond to the partial match value, wherein the candidate signatures are a superset of true matches to the object under analysis; compare the object under analysis to the candidate signatures; and if the compare identifies one or more matching signature, classify the object under analysis as belonging to a same class as at least one second object that is a source of a matching signature.

There is also disclosed an example, wherein the second object is a malware object, and wherein classifying the object under analysis comprises classifying the object under analysis as malware, and wherein the remote service is a malware service.

There is also disclosed an example, wherein the partial match algorithm is a hash.

There is also disclosed an example, wherein the partial match algorithm is a MinHash.

There is also disclosed an example, wherein the MinHash has a resolution of between 64 and 256 bits.

There is also disclosed an example, wherein the MinHash has a resolution of 128 bits.

There is also disclosed an example, wherein the MinHash has a resolution of 256 bits.

There is also disclosed an example, wherein the extracted data comprise a list of strings that occur in the object under analysis.

There is also disclosed an example, wherein comparing the object under analysis to the candidate signatures comprises comparing the object under analysis to each of the candidate signatures.

There is also disclosed an example, further comprising caching the candidate signatures to a signature cache.

There is also disclosed an example, wherein the instructions are further to search the signature cache for the candidate signatures before comparing the object under analysis to the candidate signatures.

There is also disclosed an example, wherein the instructions are further to identify one or more missing signatures not found in the signature cache, and to request the missing signatures from the remote service.

There is also disclosed an example, wherein the signature cache is a device-local signature cache.

There is also disclosed an example of one or more tangible, nontransitory computer-readable storage media having stored thereon executable instructions to: identify a test object for analysis; compute a partial match value for the test object based on one or more properties or elements of the test object; send the partial match value to a cloud service; receive from the cloud service a list of match candidates based on the partial match value, wherein the match candidates comprise signatures for objects that may match but are not guaranteed to match the test object; determine whether the match candidates are available in a local signature store; if one or more missing match candidates are not available in the local signature store, download the missing match candidates from the cloud service; compare the test object to the match candidates; and if a matching signature is found, assign the test object a reputation according to a property of the matching signature, wherein the matching signature is a signature selected from the match candidates that matches to the test object.

There is also disclosed an example, wherein the matching signature is for a malware object, and wherein classifying the test object comprises classifying the test object as malware, and wherein the cloud service is a malware service.

There is also disclosed an example, wherein computing the partial match value comprises computing a hash.

There is also disclosed an example, wherein computing the partial match value comprises computing a MinHash.

There is also disclosed an example, wherein the MinHash has a resolution of between 64 and 256 bits.

There is also disclosed an example, wherein the MinHash has a resolution of 128 bits.

There is also disclosed an example, wherein the MinHash has a resolution of 256 bits.

There is also disclosed an example, wherein the one or more properties or elements comprise a list of strings that occur in the test object.

There is also disclosed an example, wherein comparing the test object to the match candidates comprises comparing the test object to each of match candidates.

There is also disclosed an example, further comprising caching match candidates to a signature cache.

There is also disclosed an example, wherein the instructions are further to search the signature cache for the match candidates.

There is also disclosed an example, wherein the instructions are further to identify one or more missing signatures not found in the signature cache, and to request the missing signatures from the cloud service.

There is also disclosed an example, wherein the signature cache is a device-local signature cache.

There is also disclosed an example of a computer-implemented method of assigning a reputation to a portable executable (PE), comprising: designating the PE for analysis; extracting data or metadata from the PE, wherein the data or metadata are usable to provide a security reputation for the PE; computing a MinHash from the data or metadata, wherein the MinHash has a resolution between 64 and 256 bits; sending the MinHash to a cloud service; receiving from the cloud service a list of candidate signatures that match the MinHash; comparing the PE to the candidate signatures; and if a matching signature is found, assigning the PE a reputation that corresponds to an object from which the matching signature was taken.

There is also disclosed an example, wherein the MinHash has a resolution of 128 bits.

There is also disclosed an example, wherein the MinHash has a resolution of 256 bits.

There is also disclosed an example, wherein the data or metadata comprise a list of strings that occur in the PE.

There is also disclosed an example, wherein comparing the PE to the candidate signatures comparing the PE to each of the candidate signatures.

There is also disclosed an example, further comprising caching the candidate signatures to a local cache.

There is also disclosed an example, further comprising searching the local cache for the candidate signatures before comparing the PE to the candidate signatures.

There is also disclosed an example, further comprising identifying one or more missing objects not found in the local cache, and requesting the missing objects from the cloud service.

There is also disclosed an example, wherein the local cache is a device-local cache.

There is also disclosed an example of an apparatus comprising means for performing the method.

There is also disclosed an example, wherein the means for performing the method comprise a processor and a memory.

There is also disclosed an example, wherein the memory comprises machine-readable instructions that, when executed, cause the apparatus to perform the method.

There is also disclosed an example, wherein the apparatus is a computing system.

There is also disclosed an example of at least one computer-readable medium comprising instructions that, when executed, implement a method or realize an apparatus as described.

A system and method for providing a selective security scan to reduce signature candidates will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

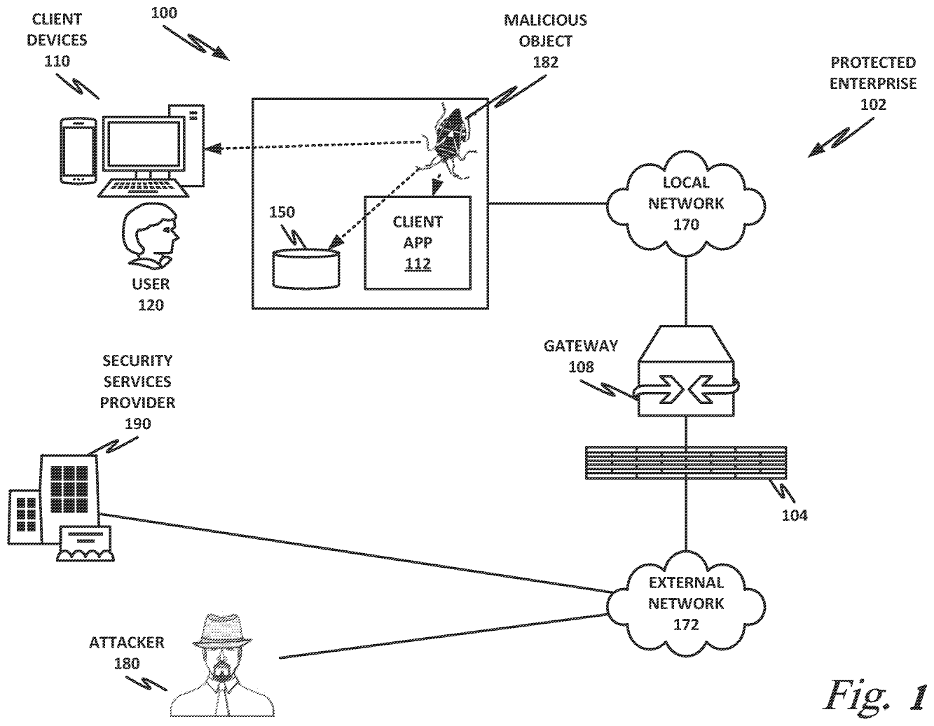

FIG. 1 is a block diagram of a security ecosystem 100. In the example of FIG. 1, security ecosystem 100 may be an enterprise, a government entity, a data center, a telecommunications provider, a “smart home” with computers, smart phones, and various IoT devices, or any other suitable ecosystem. Security ecosystem 100 is provided herein as an illustrative and nonlimiting example of a system that may employ, and benefit from, the teachings of the present specification.

Security ecosystem 100 may include one or more protected enterprises 102. A single protected enterprise 102 is illustrated here for simplicity, and could be a business enterprise, a government entity, a family, a nonprofit organization, a church, or any other organization that may subscribe to security services provided, for example, by security services provider 190.

Within security ecosystem 100, one or more users 120 operate one or more client devices 110. A single user 120 and single client device 110 are illustrated here for simplicity, but a home or enterprise may have multiple users, each of which may have multiple devices, such as desktop computers, laptop computers, smart phones, tablets, hybrids, or similar.

Client devices 110 may be communicatively coupled to one another and to other network resources via local network 170. Local network 170 may be any suitable network or combination of one or more networks operating on one or more suitable networking protocols, including a local area network, a home network, an intranet, a virtual network, a wide area network, a wireless network, a cellular network, or the internet (optionally accessed via a proxy, virtual machine, or other similar security mechanism) by way of nonlimiting example. Local network 170 may also include one or more servers, firewalls, routers, switches, security appliances, antivirus servers, or other network devices, which may be single-purpose appliances, virtual machines, containers, or functions. Some functions may be provided on client devices 110.

In this illustration, local network 170 is shown as a single network for simplicity, but in some embodiments, local network 170 may include any number of networks, such as one or more intranets connected to the internet. Local network 170 may also provide access to an external network, such as the internet, via external network 172. External network 172 may similarly be any suitable type of network.

Local network 170 may connect to the internet via gateway 108, which may be responsible, among other things, for providing a logical boundary between local network 170 and external network 172. Local network 170 may also provide services such as dynamic host configuration protocol (DHCP), gateway services, router services, and switching services, and may act as a security portal across local boundary 104.

In some embodiments, gateway 108 could be a simple home router, or could be a sophisticated enterprise infrastructure including routers, gateways, firewalls, security services, deep packet inspection, web servers, or other services.

In further embodiments, gateway 108 may be a standalone internet appliance. Such embodiments are popular in cases in which ecosystem 100 includes a home or small business. In other cases, gateway 108 may run as a virtual machine or in another virtualized manner. In larger enterprises that features service function chaining (SFC) or NFV, gateway 108 may be include one or more service functions and/or virtualized network functions.

Local network 170 may communicate across local boundary 104 with external network 172. Local boundary 104 may represent a physical, logical, or other boundary. External network 172 may include, for example, websites, servers, network protocols, and other network-based services. In one example, an attacker 180 (or other similar malicious or negligent actor) also connects to external network 172. A security services provider 190 may provide services to local network 170, such as security software, security updates, network appliances, or similar. For example, MCAFEE, LLC provides a comprehensive suite of security services that may be used to protect local network 170 and the various devices connected to it.

It may be a goal of users 120 to successfully operate devices on local network 170 without interference from attacker 180. In one example, attacker 180 is a malware author whose goal or purpose is to cause malicious harm or mischief, for example, by injecting malicious object 182 into client device 110. Once malicious object 182 gains access to client device 110, it may try to perform work such as social engineering of user 120, a hardware-based attack on client device 110, modifying storage 150 (or volatile memory), modifying client application 112 (which may be running in memory), or gaining access to local resources. Furthermore, attacks may be directed at IoT objects. IoT objects can introduce new security challenges, as they may be highly heterogeneous, and in some cases may be designed with minimal or no security considerations. To the extent that these devices have security, it may be added on as an afterthought. Thus, IoT devices may in some cases represent new attack vectors for attacker 180 to leverage against local network 170.

Malicious harm or mischief may take the form of installing root kits or other malware on client devices 110 to tamper with the system, installing spyware or adware to collect personal and commercial data, defacing websites, operating a botnet such as a spam server, or simply to annoy and harass users 120. Thus, one aim of attacker 180 may be to install his malware on one or more client devices 110 or any of the IoT devices described. As used throughout this specification, malicious software (“malware”) includes any object configured to provide unwanted results or do unwanted work. In many cases, malware objects will be executable objects, including, by way of nonlimiting examples, viruses, Trojans, zombies, rootkits, backdoors, worms, spyware, adware, ransomware, dialers, payloads, malicious browser helper objects, tracking cookies, loggers, or similar objects designed to take a potentially-unwanted action, including, by way of nonlimiting example, data destruction, data denial, covert data collection, browser hijacking, network proxy or redirection, covert tracking, data logging, keylogging, excessive or deliberate barriers to removal, contact harvesting, and unauthorized self-propagation. In some cases, malware could also include negligently-developed software that causes such results even without specific intent.

In enterprise contexts, attacker 180 may also want to commit industrial or other espionage, such as stealing classified or proprietary data, stealing identities, or gaining unauthorized access to enterprise resources. Thus, attacker 180's strategy may also include trying to gain physical access to one or more client devices 110 and operating them without authorization, so that an effective security policy may also include provisions for preventing such access.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device. Buffer overruns may be the result, for example, of poor input validation or use of insecure libraries, and in many cases arise in nonobvious contexts. Thus, although not malicious, a developer contributing software to an application repository or programming an IoT device may inadvertently provide attack vectors for attacker 180. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new objects that must themselves be validated.

Protected enterprise 102 may contract with or subscribe to a security services provider 190, which may provide security services, updates, antivirus definitions, patches, products, and services. MCAFEE, LLC is a nonlimiting example of such a security services provider that offers comprehensive security and antivirus solutions. In some cases, security services provider 190 may include a threat intelligence capability such as the global threat intelligence (GTI™) database provided by MCAFEE, LLC, or similar competing products. Security services provider 190 may update its threat intelligence database by analyzing new candidate malicious objects as they appear on client networks and characterizing them as malicious or benign.

Other security considerations within security ecosystem 100 may include parents' or employers' desire to protect children or employees from undesirable content, such as pornography, adware, spyware, age-inappropriate content, advocacy for certain political, religious, or social movements, or forums for discussing illegal or dangerous activities, by way of nonlimiting example.

One of the services provided by security services provider 190 may include a database of signatures or other fingerprints that are used to recognize malicious objects like malicious object 182. For example, client device 110 may have a security agent that scans newly encountered objects to determine if they are malicious. This may include a database of known malicious objects or signatures or fingerprints associated with known malicious objects. When the security agent scans malicious object 182 and finds a match, the object can then be classified as malicious.

In some existing ecosystems, security services provider 190 provides its full fingerprint database to every endpoint device 110 across multiple enterprises. As discussed above, this can be inefficient and becomes unscalable as the size of the fingerprint database increases. Thus, it is advantageous for client device 110 to instead operate a security client that performs a partial match algorithm, such as a MinHash, and then receives from security services provider 190 only a subset of all possible fingerprints or signatures for various objects. Client device 110 can then scan the newly encountered object against that smaller subset, thus providing a more efficient scan without a need for every endpoint device 110 to completely mirror the signature database available from security services provider 190.

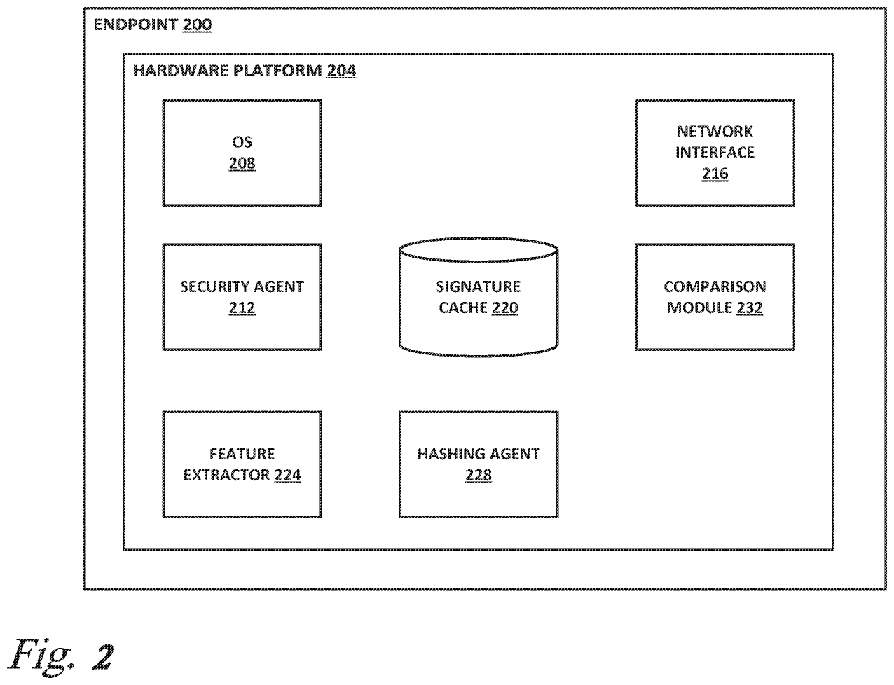

FIG. 2 is a block diagram of an endpoint device 200. Endpoint device 200 may be an example of a computing apparatus, such as those illustrated in 110 of FIG. 1 or some other suitable endpoint device.

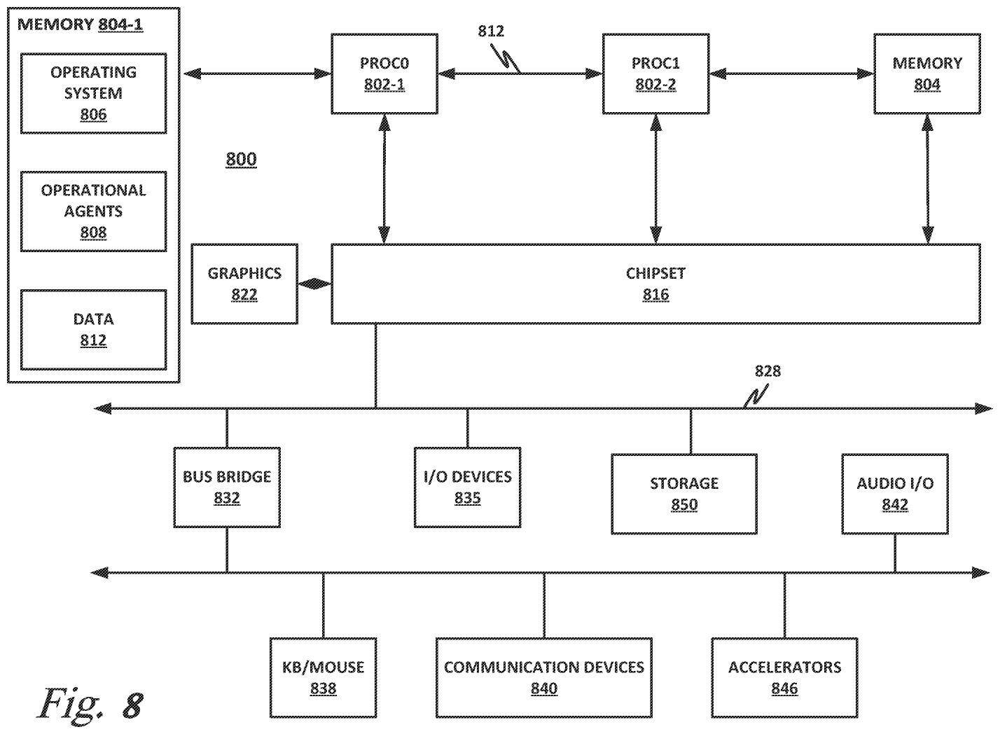

Endpoint 200 could be embodied on a hardware platform 204, which could be, for example, a hardware platform as illustrated in FIG. 8, or some other suitable hardware platform. In particular, hardware platform 204 includes a processor, a memory, and other hardware that provides the necessary computing infrastructure for endpoint 200 to carry out its functions.

Endpoint 200 provides various software modules. The modules illustrated herein could be embodied as software stored on one or more tangible transitory or nontransitory computer-readable storage media, which have stored thereon computer executable instructions to carry out certain functions. A processor of hardware platform 204 could load these instructions from a memory of hardware platform 204 and then execute them at a desired time.

In this case, endpoint 200 provides an operating system 208, which includes low-level functionality that interfaces between other software modules and hardware platform 204. Hardware platform 204 may also include a network interface 216, which may also include software such as drivers, that are part of or that interact with operating system 208. Network interface 216 may provide the necessary hardware, such as a wired or wireless internet or network connection, and may interface with appropriate software to provide a network stack, such as the traditional OSI seven-layer stack or the TCP/IP seven-layer stack.

Endpoint 200 includes a security agent 212. Security agent 212 may be a software package that provides security services to endpoint 200 and may be provided by vendors, such as security services provider 190 of FIG. 1. Security agent 212, in some cases, runs a privileged process and has the ability to monitor and/or control other applications within endpoint 200. Security agent 212 also includes or interacts with a feature extractor 224, a hashing agent 228, a signature cache 220, and a comparison module 232. These elements may be useful in providing the methods disclosed herein. For example, feature extractor 224 may be used to extract features (such as a list of all included strings) from an object under analysis or a test subject. Hashing agent 228 may be used to compute a partial match algorithm, such as a hash or more specifically a MinHash of the extracted data. Comparison module 232 may be used to compare the extracted features to signatures within a signature cache 220. Signature cache 220 may include either a limited cache of only some signatures or the full hash database depending on whether endpoint 200 uses the teachings of the present specification.

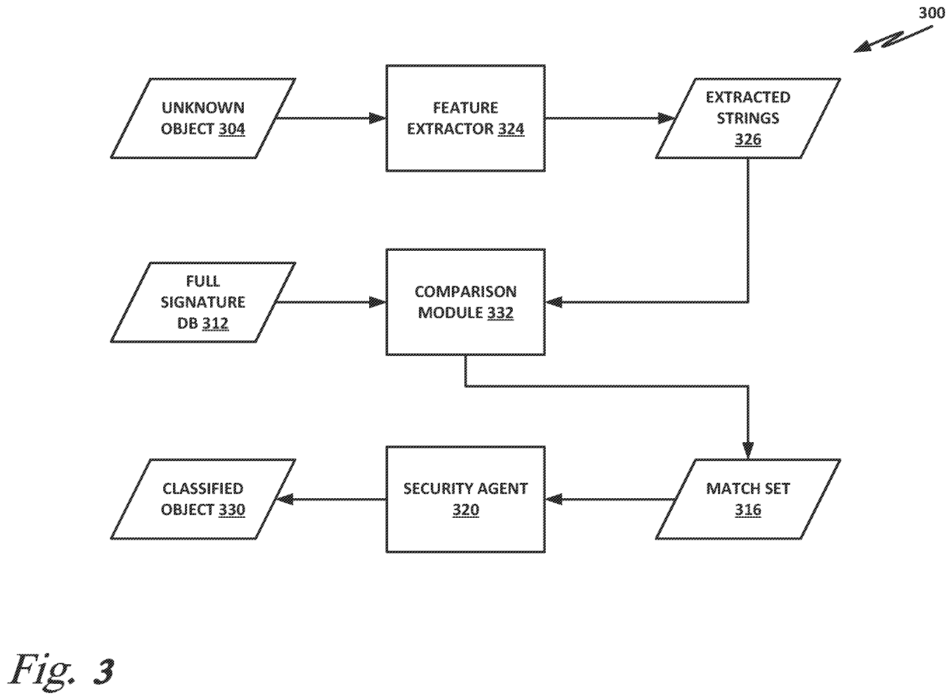

FIG. 3 is a block diagram of a processing pipeline 300. Processing pipeline may be used to carry out analysis of a test subject or some other object under analysis. Processing pipeline 300, in some cases, uses a full signature database. For example, full signature database 312 could be a database that is loaded with the entire signature set from a security services provider.

In this pipeline example, the device encounters an unknown object 304. Feature extractor 324 extracts from unknown object 304 relevant features, such as a list of strings, a hash, a signature, or other data about the unknown object. Feature extractor 324 then provides the extracted features such as a list of extracted strings 326.

Comparison module 332 receives the extracted data, such as extracted strings 326, and compares the extracted strings to full signature database 312. The comparison of extracted strings to the full signature database is performed by many existing systems. Comparison module 332 then provides a match set 316. Match set 316 includes matches between extracted strings 326 and full signature database 312. Full signature database 312 may also include reputations or other information about the known strings. For example, some of the known strings represent benign or useful applications while others represent attacks or malware. Thus, when extracted strings 326 are matched to signatures from full signature database 312, unknown object 304 may be deemed to inherit reputations or properties from the matching objects. Thus, security agent 320 receives match set 316. Security agent 320 may then assign properties to unknown object 304 based on matches within match set 316. For example, it may assign the same properties or attributes as those objects to which the unknown object matched. Thus, security agent 320 provides a classified object 330.

Classified object 330 can then be treated appropriately. If classified object 330 has been classified as malicious or an attack, then appropriate action can be taken, such as quarantining the object, sandboxing the object, deleting the object, further analyzing the object, or taking some other security action. If classified object 330 is classified as unknown, then other appropriate security action may be taken, such as subjecting the object to additional security analysis or scrutiny, providing classified object 330 to a cloud service for additional analysis, or some other action to better characterize classified object 330. If classified object 330 is classified as benign or useful, then appropriate action may be taken, such as permitting classified object 330 to operate on the local system and to perform its intended function.

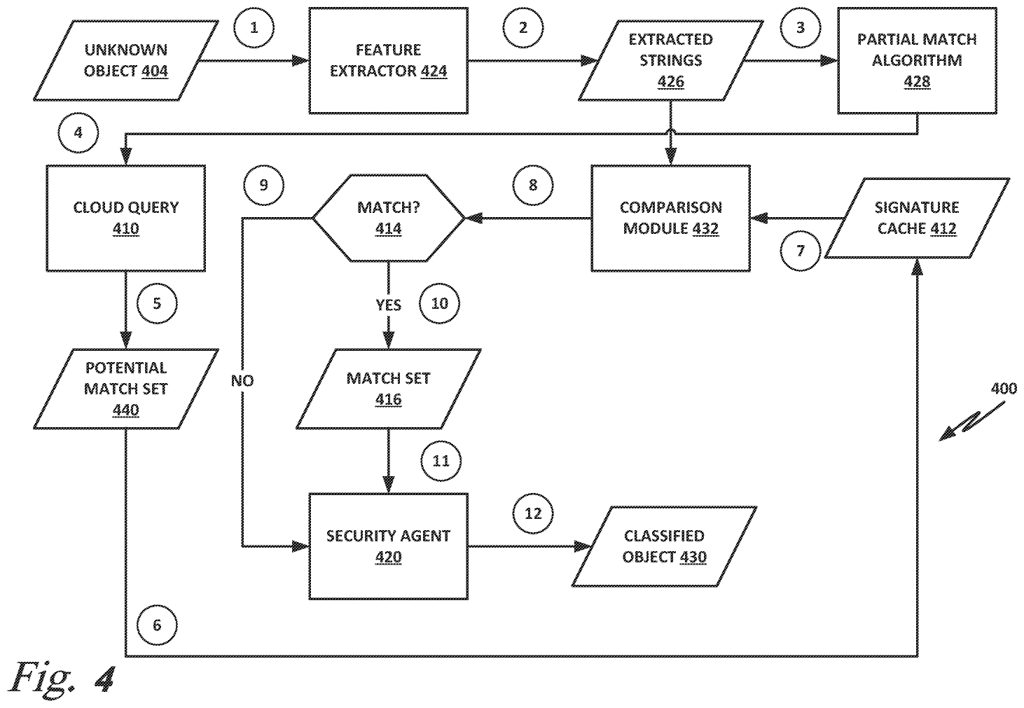

FIG. 4 is a block diagram of a processing pipeline 400. Processing pipeline 400 includes some additional processing relative to processing pipeline 300 of FIG. 3. In particular, processing pipeline 400 may use a partial match algorithm to reduce the set of signatures that an object is compared to. This may include receiving only a subset of potentially matching signatures from a cloud service, in contrast to mirroring the entire signature database.

In FIG. 4, because the processing may be nonlinear, certain operations are numbered for convenience of reference.

At operation 1, the system encounters an unknown object 404. Unknown object 404 is provided to feature extractor 424.

At operation 2, feature extractor 424 analyzes the unknown object and extracts features, such as strings, or other properties as described in FIG. 3.

At operation 3, extracted strings 426 are provided to partial match algorithm 428. Partial match algorithm 428 performs an algorithm, such as MinHash or similar, on the extracted strings 426.

At operation 4, partial match algorithm 428 provides the partial match results (e.g., a MinHash) to a cloud query 410. Cloud query 410 queries the cloud service for the provided partial match result.

At operation 5, the cloud service returns a potential match set 440, if any. The potential match set or candidate set is a set of signatures, strings, fingerprints, or other data that is a guaranteed superset of the exact matches to extracted strings 426. Stated conversely, the exact matches to extracted strings 426 are a subset of potential match set 440. As described above, partial match algorithm 428 is selected so that true matches are guaranteed to appear in the potential match set 440, but there is also expected to be a number of false positives. However, false positives are not a problem because additional matching will be performed.

Partial match set 440 may be cached in signature cache 412.

At operation 7, comparison module 432 receives extracted strings 426 and compares them to the cached signatures in signature cache 412.

At operation 8, the system determines whether there is a match 414 to the signatures within signature cache 412.

In operation 9, the system informed security agent 420 that there is no match. Security agent 420 can then appropriately classify the object, such as giving the object a benign or unknown reputation.

Returning to decision 414, if there is a match, then in operation 10, match set 416 is provided to security agent 420. In operation 11, security agent 420 assigns a reputation or other classification to the object according to the match. For example, the object may inherit the reputation of the object that it matched to or to an object from which the matching signature was derived. In operation 12, security agent 420 provides a classified object 430.

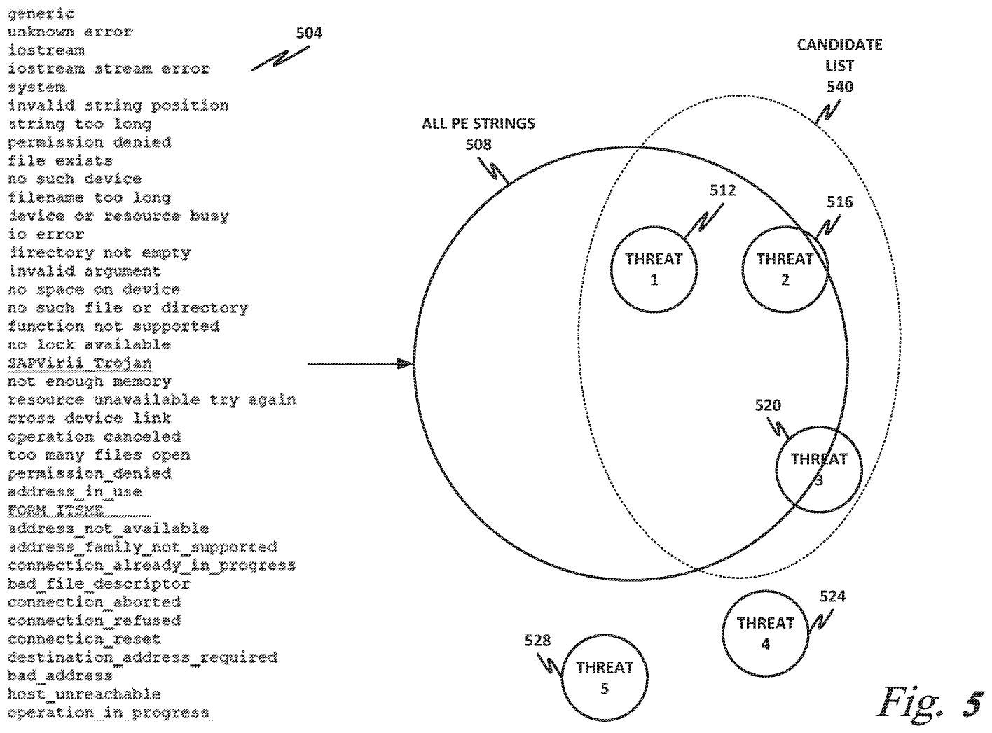

FIG. 5 is a block diagram illustrating the operation of a partial match algorithm.

In this example, an endpoint has extracted data, such as a list of strings 504, from an object, such as a PE. This list of strings is provided as the object “all PE strings” 508. The endpoint may then receive a list of candidates, such as signatures, IDs, versions, or other information that may be used to scan the target sample. Note that this illustrates a single test sample scenario, but the solution could be extended to cover a batch of samples. The difference is that a single query could handle multiple MinHashes and return candidates for multiple test samples.

When the endpoint is prepared to scan the test samples using a list of candidates, it obtains the content of the candidates or, in other words, the content of signatures that need to be checked against. If the endpoint has recently obtained and used the candidates, then the candidate's content may be present in the cache. If the content is not present in the cache, then the content may first need to be retrieved from the cloud service. Once the content is received, then scanning can occur. In this case, threat 1 512 includes all of the strings included in all PE strings object 508, and may be considered a “true match” to the PE. In other words, the PE may be identical to threat 1 512, or it may have been built using the same malware toolkit or method, so that it is functionally identical or nearly identical. Thus, threat 1 512 should be included in a MinHash of all PE strings 508.

Threat 2 516 is a near match, in that it includes most of the strings from all PE strings 508. Depending on the matching algorithm being used, threat 2 516 may be considered a true match, or a false positive. In either case, it may be similar enough to all PE strings 508 that it matches on the MinHash.

Threat 3 520 includes some common strings with all PE strings 508. As before, threat 3 520 may be considered a true match or a false positive, depending on the “fuzziness” of the true match algorithm used.

Threat 4 524 and threat 5 528 do not contain common strings with all PE strings 508.

Using an appropriate MinHash depth, such as 128 bits or 256 bits, threat 1 512, threat 2 516, and threat 3 520 may be considered LSH ensemble containment candidates. When the endpoint device performs a MinHash and provides the MinHash value to the cloud service, the cloud service may use LSH ensemble to match the MinHash value to threat 1 512, threat 2 516, and threat 3, 520. These three values form a candidate match list 540, or in other words, a list of “candidate” signatures that might match (but are not guaranteed to match) the test sample.

The endpoint may then check its local cache to see if the string lists for the objects within candidate match list 540 are already included in its local cache. If they are not, then the endpoint may query the cloud service for any string lists (or other signature data) missing from the set. Once the endpoint has all string lists/signatures for candidate match list 540, it can compare the test sample to each signature or string list in the set, and determine whether there are any true matches. If zero true matches are found, then the object does not match to any known object (e.g., any known malware), and may receive an appropriate reputation from the security agent. If there is a match, then the test sample may inherit a reputation from one or more matches. For example, if the test sample is found to be a true match to a known malware sample, the test sample may be convicted as malware, and appropriately quarantined or otherwise handled.

In this example, threat 4 524 and threat 5 528 are excluded from the results list, because they are not found to be matches to the MinHash algorithm. In reality, the number of non-matching samples may be orders of magnitude higher than the number of matching samples. This realizes advantages, because the endpoint does not need to store signatures for the many non-matching samples. Because the endpoint receives only the content that is needed and relevant to the present task, it does not need to retrieve a bulky package of everything that is available on the cloud service. This is less costly and more efficient for scanning purposes.

Once the endpoint obtains all the candidates' content, it can start the scan process. In this case, because the MinHash and LSH ensemble containment algorithms have returned only a subset of all available signatures, the endpoint will scan only a small subset of signatures or patterns. This can provide a scan process that may be orders of magnitude faster than in certain existing mechanisms.

Another advantage is that this endpoint only stores small chunks of signatures and grows or expires the content as needed, on demand. This implies that content is no longer limited to endpoint restrictions, such as a disk or memory footprint. The content is dynamic and may grow or be trimmed differently for different endpoints. Furthermore, real-time content can be updated on-the-fly in the cloud. The next time an endpoint encounters an object, it will receive fresh content without the need of providing a traditional periodic update mechanism. This provides the ability to support low resource devices, such as IoT devices, embedded devices, headless devices, and similar.

Furthermore, endpoints can take a determination to classify a test sample based on matching or not matching candidates' content. At the same time, the endpoint can place recent content in a cache, which optionally may include a TTL. This can ensure fast scans take place during a short period.

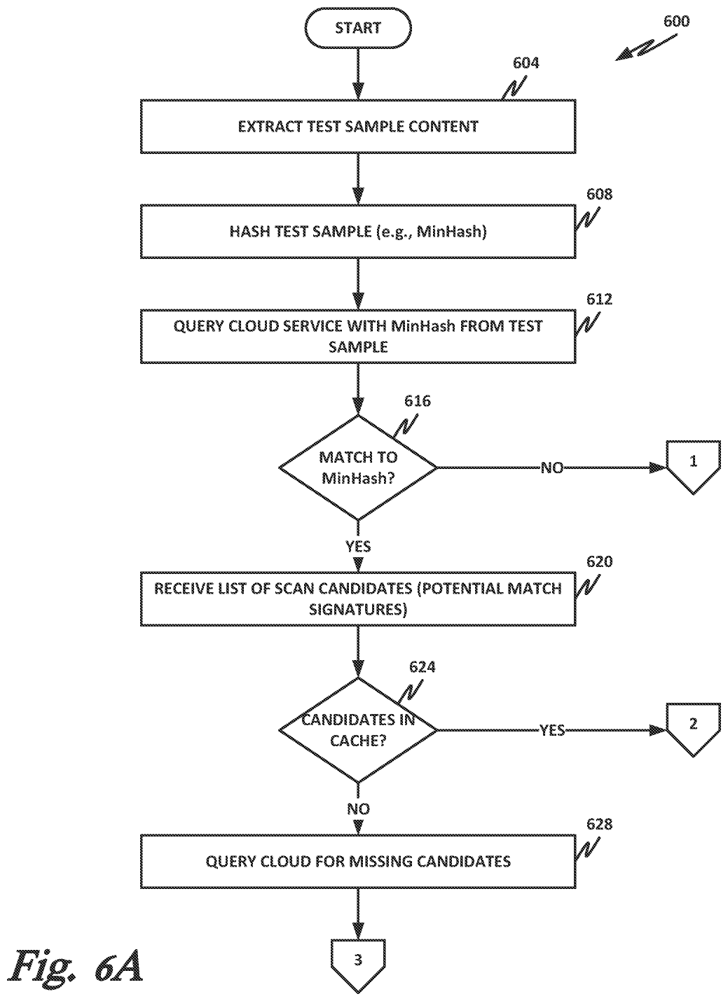

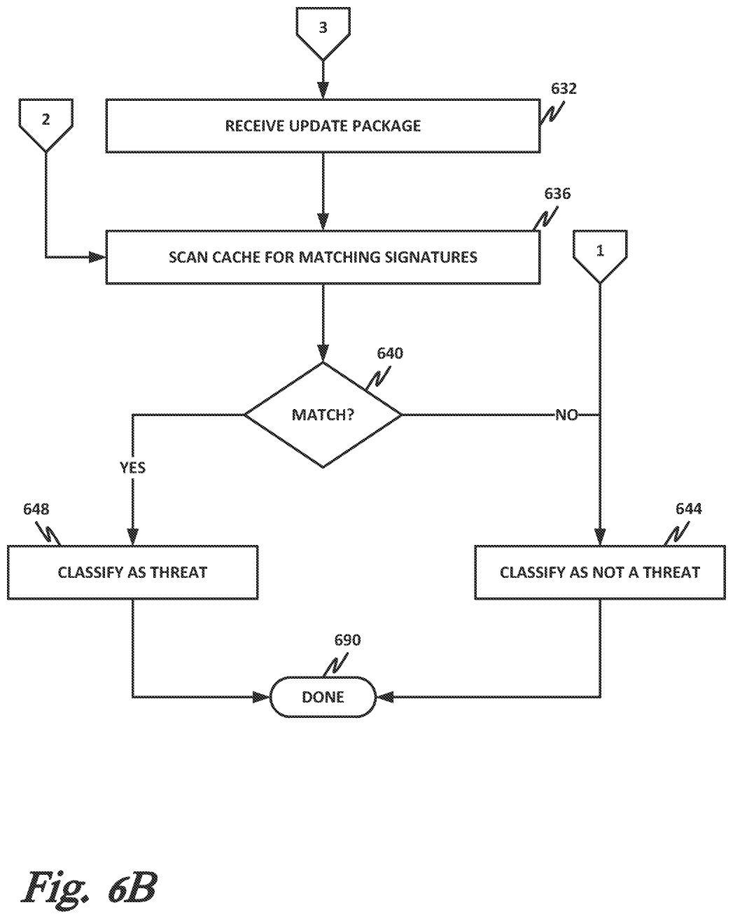

FIGS. 6A and 6B are a flowchart of a method 600. Method 600 includes an illustrative method of using a partial match algorithm to provide a subset for scanning with a cloud service.

In block 604, the system may extract content from a test sample. As illustrated above, this could include extracting all strings from a PE file or extracting other data or metadata from a file.

In block 608, a partial match algorithm or other hash may be applied to a test sample. In a particular example, the MinHash algorithm may be used as a partial match algorithm.

In block 612, the system may query a cloud service with the MinHash provided from the test sample.

In decision block 616, the system determines whether the cloud provided a match to the MinHash algorithm.

If no match was provided, then following off page connector 1 to FIG. 6B, in block 644, the system may classify the object is not a threat. In other words, the object did not match to any known malware or malicious object, and thus can be considered benign. Other classification algorithms could be used, such as classifying the object as unknown, suspicious, or performing additional analysis.

Returning to decision block 616, if the cloud does return a match to the MinHash algorithm, then in block 620, the system receives a list of scan candidates. These include potential match signatures. As described above, this set is guaranteed to include any true matches and may also include some number of false positives. The balance between true matches and false positives may depend on the resolution or depth of the MinHash algorithm. For example, a 256-bit MinHash has been found to provide a useful balance between true matches and false positives. In other examples, other values of MinHash could be used including 128 bits, values greater than 256, and values less than 256.

In decision block 624, the system determines whether the candidate signatures are already located in the cache. In other words, before downloading new signatures, the system may first check its local cache to see if those signatures are already available in the cache.

Following off page connector 2 to FIG. 6B, if the signatures are already in the local cache, then in block 636, the system scans the cache for matching signatures.

In decision block 640, the system determines whether the test sample matches any of the known signatures.

If there is a match to a known malicious object, then in block 648, the test sample may be classified as a threat. In other words, the test sample may inherit the reputation of the object from which the matching signature was derived.

Returning to decision block 640, if there is no match, then the object has not matched to a known malware object, and in block 644, may be classified as not a threat. As before, other classification mechanisms could be used.

Returning to decision block 624 of FIG. 6A, if the candidate signatures are not found in the local cache, then in block 628, the endpoint system may query the cloud for the missing candidates.

Following off page connector 3 to FIG. 6B, in block 632, the endpoint receives an update package. Advantageously, the update package is not a mirror of the entire signature database but rather includes only those signatures needed to complete the partial match in the local cache. The returned signatures can then be stored to the local cache.

The system then returns to block 636 where the object under analysis or the metadata from the object under analysis may be compared to signatures in the local signature cache, which is now complete as to the subset that matches the MinHash algorithm. Control then proceeds as previously described, and in block 690, the method is done.

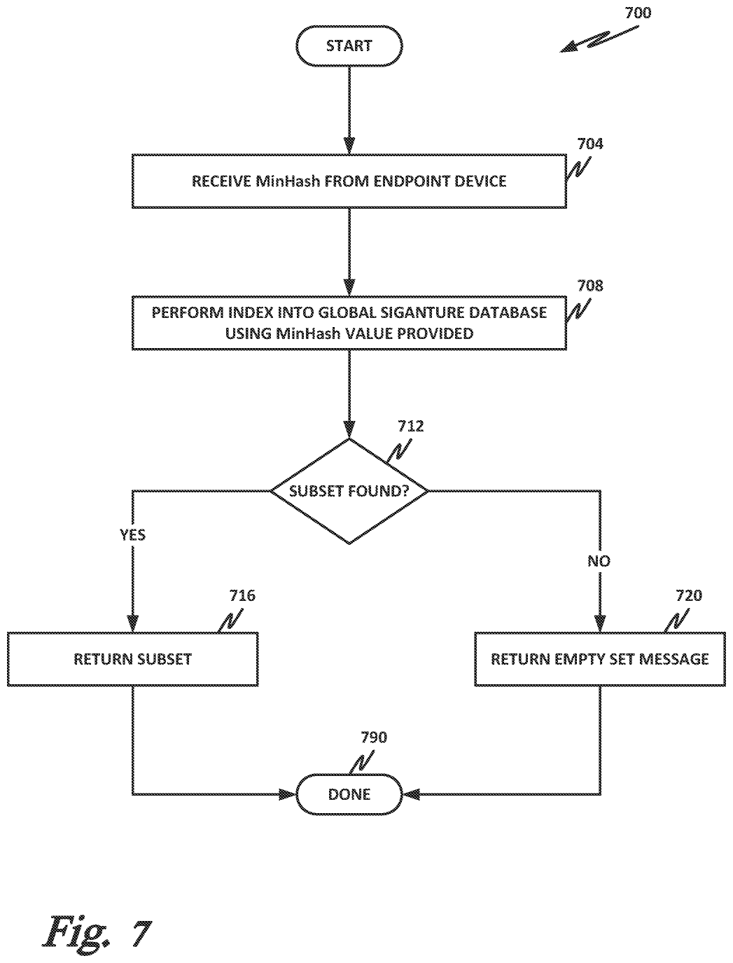

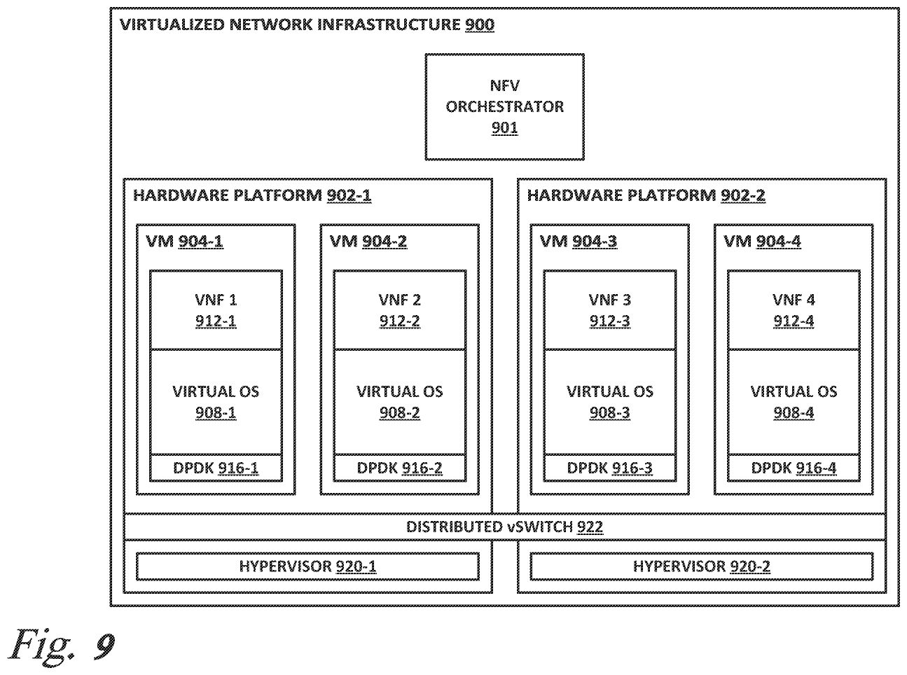

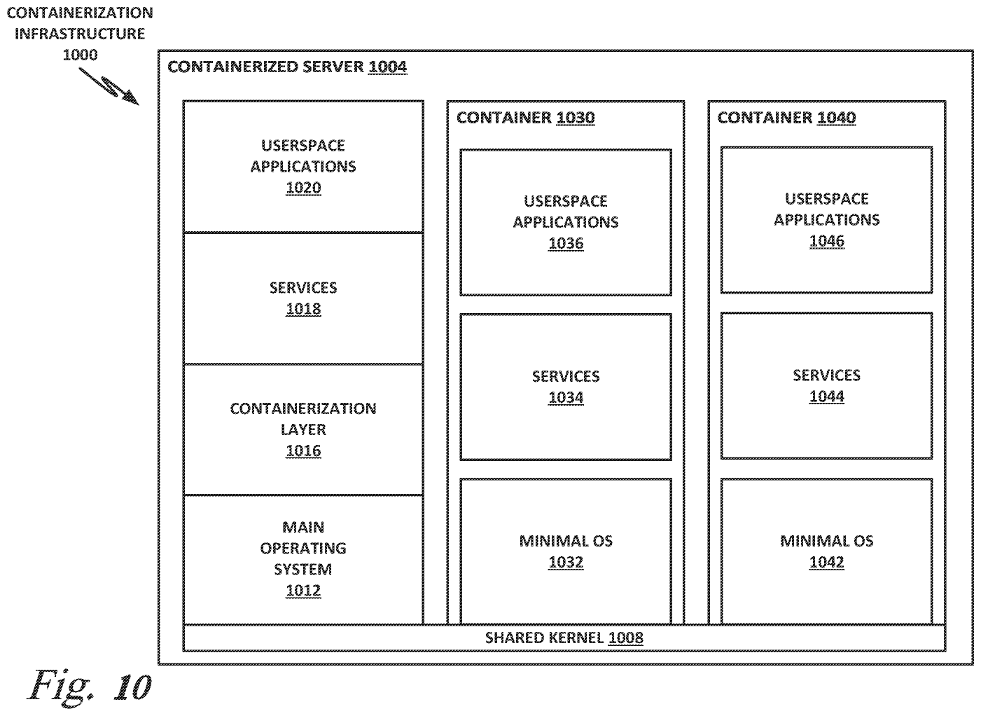

FIG. 7 is a flowchart of a method 700. Method 700 may be performed by a cloud service. In some examples, the cloud service may be implemented via a virtualization infrastructure as illustrated in FIG. 9 or a containerization infrastructure as illustrated in FIG. 10. In other examples, a dedicated hardware service or other cloud infrastructure could be provided.

In block 704, cloud service receives a MinHash value from an endpoint device.

In block 708, the cloud service uses the received MinHash value as an index into its global signature database. This index is used to provide a subset of potential matches within the global signature database.

In decision block 712, the cloud service determines whether any subset was found. If a subset was found, then in block 716, the subset may be returned to the endpoint. Note that in some cases, the endpoint may already have at least part of the subset locally cached. In that case, the cloud may return only identifiers for the matching signatures. It may then wait for a further query from the endpoint if the endpoint requires at least some of the signatures to be provided as an update package.

Returning to decision block 712, if no subset is found, then in block 720, the cloud service returns an empty set message. This indicates to the endpoint that no matching sets were found.

After returning either a subset identifier or an empty set message, in block 790, the method is done.

FIG. 8 is a block diagram of a hardware platform 800. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 800, even though they may be scattered across a data center, or even located in different data centers.

Hardware platform 800 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 800 is arranged in a point-to-point (PtP) configuration. This PtP configuration is popular for personal computer (PC) and server-type devices, although it is not so limited, and any other bus type may be used.

Hardware platform 800 is an example of a platform that may be used to implement embodiments of the teachings of this specification. For example, instructions could be stored in storage 850. Instructions could also be transmitted to the hardware platform in an ethereal form, such as via a network interface, or retrieved from another source via any suitable interconnect. Once received (from any source), the instructions may be loaded into memory 804, and may then be executed by one or more processor 802 to provide elements such as an operating system 806, operational agents 808, or data 812.

Hardware platform 800 may include several processors 802. For simplicity and clarity, only processors PROC0 802-1 and PROC1 802-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 802 may be any type of processor and may communicatively couple to chipset 816 via, for example, PtP interfaces. Chipset 816 may also exchange data with other elements, such as a high performance graphics adapter 822. In alternative embodiments, any or all of the PtP links illustrated in FIG. 8 could be implemented as any type of bus, or other configuration rather than a PtP link. In various embodiments, chipset 816 may reside on the same die or package as a processor 802 or on one or more different dies or packages. Each chipset may support any suitable number of processors 802. A chipset 816 (which may be a chipset, uncore, Northbridge, Southbridge, or other suitable logic and circuitry) may also include one or more controllers to couple other components to one or more central processor units (CPU).

Two memories, 804-1 and 804-2 are shown, connected to PROC0 802-1 and PROC1 802-2, respectively. As an example, each processor is shown connected to its memory in a direct memory access (DMA) configuration, though other memory architectures are possible, including ones in which memory 804 communicates with a processor 802 via a bus. For example, some memories may be connected via a system bus, or in a data center, memory may be accessible in a remote DMA (RDMA) configuration.

Memory 804 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 804 may be used for short, medium, and/or long-term storage. Memory 804 may store any suitable data or information utilized by platform logic. In some embodiments, memory 804 may also comprise storage for instructions that may be executed by the cores of processors 802 or other processing elements (e.g., logic resident on chipsets 816) to provide functionality.

In certain embodiments, memory 804 may comprise a relatively low-latency volatile main memory, while storage 850 may comprise a relatively higher-latency nonvolatile memory. However, memory 804 and storage 850 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 804 and storage 850, for example, in a single physical memory device, and in other cases, memory 804 and/or storage 850 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 822 may be configured to provide a human-readable visual output, such as a command-line interface (CLI) or graphical desktop such as Microsoft Windows, Apple OSX desktop, or a Unix/Linux X Window System-based desktop. Graphics adapter 822 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 822 may include a hardware graphics card, which may have its own memory and its own graphics processing unit (GPU).

Chipset 816 may be in communication with a bus 828 via an interface circuit. Bus 828 may have one or more devices that communicate over it, such as a bus bridge 832, I/O devices 835, accelerators 846, communication devices 840, and a keyboard and/or mouse 838, by way of nonlimiting example. In general terms, the elements of hardware platform 800 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 840 can broadly include any communication not covered by a network interface and the various I/O devices described herein. This may include, for example, various universal serial bus (USB), FireWire, Lightning, or other serial or parallel devices that provide communications.

I/O Devices 835 may be configured to interface with any auxiliary device that connects to hardware platform 800 but that is not necessarily a part of the core architecture of hardware platform 800. A peripheral may be operable to provide extended functionality to hardware platform 800, and may or may not be wholly dependent on hardware platform 800. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 842 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 832 may be in communication with other devices such as a keyboard/mouse 838 (or other input devices such as a touch screen, trackball, etc.), communication devices 840 (such as modems, network interface devices, peripheral interfaces such as PCI or PCIe, or other types of communication devices that may communicate through a network), audio I/O 842, a data storage device 844, and/or accelerators 846. In alternative embodiments, any portions of the bus architectures could be implemented with one or more PtP links.

Operating system 806 may be, for example, Microsoft Windows, Linux, UNIX, Mac OS X, iOS, MS-DOS, or an embedded or real-time operating system (including embedded or real-time flavors of the foregoing). In some embodiments, a hardware platform 800 may function as a host platform for one or more guest systems that invoke application (e.g., operational agents 808).

Operational agents 808 may include one or more computing engines that may include one or more nontransitory computer-readable mediums having stored thereon executable instructions operable to instruct a processor to provide operational functions. At an appropriate time, such as upon booting hardware platform 800 or upon a command from operating system 806 or a user or security administrator, a processor 802 may retrieve a copy of the operational agent (or software portions thereof) from storage 850 and load it into memory 804. Processor 802 may then iteratively execute the instructions of operational agents 808 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 800 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCoE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 800 may be virtualized, in particular the processor(s) and memory. For example, a virtualized environment may run on OS 806, or OS 806 could be replaced with a hypervisor or virtual machine manager. In this configuration, a virtual machine running on hardware platform 800 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 8 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

FIG. 9 is a block diagram of a NFV infrastructure 900. NFV is an example of virtualization, and the virtualization infrastructure here can also be used to realize traditional VMs. Various functions described above may be realized as VMs, such as virtualized desktops, or any of the server functions illustrated, such as within the cloud functions of security services provider 190 of FIG. 1.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 900. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 9, an NFV orchestrator 901 may manage several VNFs 912 running on an NFVI 900. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 901 a valuable system resource. Note that NFV orchestrator 901 may provide a browser-based or graphical configuration interface, and in some embodiments may be integrated with SDN orchestration functions.

Note that NFV orchestrator 901 itself may be virtualized (rather than a special-purpose hardware appliance). NFV orchestrator 901 may be integrated within an existing SDN system, wherein an operations support system (OSS) manages the SDN. This may interact with cloud resource management systems (e.g., OpenStack) to provide NFV orchestration. An NFVI 900 may include the hardware, software, and other infrastructure to enable VNFs to run. This may include a hardware platform 902 on which one or more VMs 904 may run. For example, hardware platform 902-1 in this example runs VMs 904-1 and 904-2. Hardware platform 902-2 runs VMs 904-3 and 904-4. Each hardware platform 902 may include a respective hypervisor 920, virtual machine manager (VMM), or similar function, which may include and run on a native (bare metal) operating system, which may be minimal so as to consume very few resources. For example, hardware platform 902-1 has hypervisor 920-1, and hardware platform 902-2 has hypervisor 920-2.

Hardware platforms 902 may be or comprise a rack or several racks of blade or slot servers (including, e.g., processors, memory, and storage), one or more data centers, other hardware resources distributed across one or more geographic locations, hardware switches, or network interfaces. An NFVI 900 may also include the software architecture that enables hypervisors to run and be managed by NFV orchestrator 901.

Running on NFVI 900 are VMs 904, each of which in this example is a VNF providing a virtual service appliance. Each VM 904 in this example includes an instance of the Data Plane Development Kit (DPDK) 916, a virtual operating system 908, and an application providing the VNF 912. For example, VM 904-1 has virtual OS 908-1, DPDK 916-1, and VNF 912-1. VM 904-2 has virtual OS 908-2, DPDK 916-2, and VNF 912-2. VM 904-3 has virtual OS 908-3, DPDK 916-3, and VNF 912-3. VM 904-4 has virtual OS 908-4, DPDK 916-4, and VNF 912-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 9 shows that a number of VNFs 904 have been provisioned and exist within NFVI 900. This FIGURE does not necessarily illustrate any relationship between the VNFs and the larger network, or the packet flows that NFVI 900 may employ.

The illustrated DPDK instances 916 provide a set of highly-optimized libraries for communicating across a virtual switch (vSwitch) 922. Like VMs 904, vSwitch 922 is provisioned and allocated by a hypervisor 920. The hypervisor uses a network interface to connect the hardware platform to the data center fabric (e.g., a host fabric interface (HFI)). This HFI may be shared by all VMs 904 running on a hardware platform 902. Thus, a vSwitch may be allocated to switch traffic between VMs 904. The vSwitch may be a pure software vSwitch (e.g., a shared memory vSwitch), which may be optimized so that data are not moved between memory locations, but rather, the data may stay in one place, and pointers may be passed between VMs 904 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 922 is illustrated, wherein vSwitch 922 is shared between two or more physical hardware platforms 902.

FIG. 10 is a block diagram of selected elements of a containerization infrastructure 1000. Like virtualization, containerization is a popular form of providing a guest infrastructure. Various functions described herein may be containerized; for example, any of the server functions or cloud services disclosed herein could be containerized.

Containerization infrastructure 1000 runs on a hardware platform such as containerized server 1004. Containerized server 1004 may provide processors, memory, one or more network interfaces, accelerators, and/or other hardware resources.

Running on containerized server 1004 is a shared kernel 1008. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1008 is main operating system 1012. Commonly, main operating system 1012 is a Unix or Linux-based operating system, although containerization infrastructure is also available for other types of systems, including Microsoft Windows systems and Macintosh systems. Running on top of main operating system 1012 is a containerization layer 1016. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1012 may also provide services 1018, which provide services and interprocess communication to userspace applications 1020.

Services 1018 and userspace applications 1020 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1012, they inherit the same file and resource access permissions as those provided by shared kernel 1008. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1004, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1004).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1004 hosts two containers, namely container 1030 and container 1040.

Container 1030 may include a minimal operating system 1032 that runs on top of shared kernel 1008. Note that a minimal operating system is provided as an illustrative example, and is not mandatory. In fact, container 1030 may perform as full an operating system as is necessary or desirable. Minimal operating system 1032 is used here as an example simply to illustrate that in common practice, the minimal operating system necessary to support the function of the container (which in common practice, is a single or monolithic function) is provided.

On top of minimal operating system 1032, container 1030 may provide one or more services 1034. Finally, on top of services 1034, container 1030 may also provide userspace applications 1036, as necessary.

Container 1040 may include a minimal operating system 1042 that runs on top of shared kernel 1008. Note that a minimal operating system is provided as an illustrative example, and is not mandatory. In fact, container 1040 may perform as full an operating system as is necessary or desirable. Minimal operating system 1042 is used here as an example simply to illustrate that in common practice, the minimal operating system necessary to support the function of the container (which in common practice, is a single or monolithic function) is provided.

On top of minimal operating system 1042, container 1040 may provide one or more services 1044. Finally, on top of services 1044, container 1040 may also provide userspace applications 1046, as necessary.

Using containerization layer 1016, containerized server 1004 may run discrete containers, each one providing the minimal operating system and/or services necessary to provide a particular function. For example, containerized server 1004 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

The foregoing outlines features of several embodiments so that those skilled in the art may better understand various aspects of the present disclosure. The foregoing detailed description sets forth examples of apparatuses, methods, and systems relating to a system for providing a selective security scan to reduce signature candidates, in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without the specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected element. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1. A computing apparatus, comprising:
a hardware platform comprising a processor circuit and a memory;
a network interface; and
instructions encoded within the memory to instruct the processor circuit to:
extract data from an object under analysis;
compute a partial match value according to a partial match algorithm of the extracted data;
send the partial match value to a remote service via the network interface;
receive from the remote service, via the network interface, a list of candidate signatures that correspond to the partial match value, wherein the candidate signatures are a superset of true matches to the object under analysis;
compare the object under analysis to the candidate signatures; and
if the compare identifies one or more matching signature, classify the object under analysis as belonging to a same class as at least one second object that is a source of a matching signature.

2. The computing apparatus of claim 1, wherein the second object is a malware object, and wherein classifying the object under analysis comprises classifying the object under analysis as malware, and wherein the remote service is a malware service.

3. The computing apparatus of claim 1, wherein the partial match algorithm is a hash.

4. The computing apparatus of claim 1, wherein the partial match algorithm is a MinHash.

5. The computing apparatus of claim 4, wherein the MinHash has a resolution of between 64 and 256 bits.

6. The computing apparatus of claim 4, wherein the MinHash has a resolution of 128 bits.

7. The computing apparatus of claim 4, wherein the MinHash has a resolution of 256 bits.

8. The computing apparatus of claim 1, wherein the extracted data comprise a list of strings that occur in the object under analysis.

9. The computing apparatus of claim 1, wherein comparing the object under analysis to the candidate signatures comprises comparing the object under analysis to each of the candidate signatures.

10. The computing apparatus of claim 1, further comprising caching the candidate signatures to a signature cache.

11. The computing apparatus of claim 10, wherein the instructions are further to search the signature cache for the candidate signatures before comparing the object under analysis to the candidate signatures.

12. The computing apparatus of claim 10, wherein the instructions are further to identify one or more missing signatures not found in the signature cache, and to request the missing signatures from the remote service.

13. The computing apparatus of claim 10, wherein the signature cache is a device-local signature cache.

14. One or more tangible, nontransitory computer-readable storage media having stored thereon executable instructions to:
identify a test object for analysis;
compute a partial match value for the test object based on one or more properties or elements of the test object;
send the partial match value to a cloud service;
receive from the cloud service a list of match candidates based on the partial match value, wherein the match candidates comprise signatures for objects that may match but are not guaranteed to match the test object;
determine whether the match candidates are available in a local signature store;
if one or more missing match candidates are not available in the local signature store, download the missing match candidates from the cloud service;
compare the test object to the match candidates; and
if a matching signature is found, assign the test object a reputation according to a property of the matching signature, wherein the matching signature is a signature selected from the match candidates that matches to the test object.

15. The one or more tangible, nontransitory computer-readable media of claim 14, wherein the matching signature is for a malware object, and wherein classifying the test object comprises classifying the test object as malware, and wherein the cloud service is a malware service.

16. The one or more tangible, nontransitory computer-readable media of claim 14, wherein computing the partial match value comprises computing a hash.

17. The one or more tangible, nontransitory computer-readable media of claim 14, wherein computing the partial match value comprises computing a MinHash.

18. The one or more tangible, nontransitory computer-readable media of claim 17, wherein the MinHash has a resolution of between 64 and 256 bits.

19-26. (canceled)

27. A computer-implemented method of assigning a reputation to a portable executable (PE), comprising:
designating the PE for analysis;
extracting data or metadata from the PE, wherein the data or metadata are usable to provide a security reputation for the PE;
computing a MinHash from the data or metadata, wherein the MinHash has a resolution between 64 and 256 bits;
sending the MinHash to a cloud service;
receiving from the cloud service a list of candidate signatures that match the MinHash;
comparing the PE to the candidate signatures; and
if a matching signature is found, assigning the PE a reputation that corresponds to an object from which the matching signature was taken.

28-29. (canceled)

30. The method of claim 27, wherein the data or metadata comprise a list of strings that occur in the PE.

31-40. (canceled)
